(19) United States
(12) Patent Application Publication
(10) Pub. No.: US 2023/0025516 A1
(43) Pub. Date: Jan. 26, 2023

(54) Multi-Modal Exercise Detection Framework

(71) Applicant: Google LLC, Mountain View, CA (US)

(72) Inventors: Diane C. Wang, San Francisco, CA (US); Michael Ishigaki, Mountain View, CA (US); Elena Jessop Nattinger, San Carlos, CA (US)

(21) Appl. No.: 17/382,481

(22) Filed: Jul. 22, 2021

(51) Int. Cl. A63B 24/00; G06K 9/00; H04R 1/08; G10L 25/51; G10L 15/22; G06N 20/00; G01P 15/02

(52) U.S. Cl. CPC A63B 24/0062; G06K 9/00342; H04R 1/08; G10L 25/51; G10L 15/22; G06N 20/00; G01P 15/02; A63B 21/0724

(57) ABSTRACT

The present disclosure provides a system and method for accurately detecting exercises performed by a user through a combination of signals from a visual input device and from one or more sensors of a wearable device. For each workout type, an algorithm leverages multimodal inputs for automatic workout detection/identification. Using multiple sources of visual and gestural inputs to detect the same workout results in a higher confidence in the detection. Moreover, it allows for continued detection of the workout, including counting repetitions, even when one or more signals becomes unavailable, such as if the user moves out of a field of view of the visual input device.

### BACKGROUND

While some wearable electronic devices include fitness applications for tracking exercise by a user, the fitness applications are often limited to detecting a small set of activities, such as running. Moreover, users are often asked for substantial manual input to track the exercise. For example, the user may be asked to enter each type of exercise they are doing and the number of repetitions. Such manual entry is also not well suited for the devices a user is likely to have on hand for their workout.

Additionally tracking fitness activity and calorie expenditure via wearable devices tends to be inaccurate due to user variance, such as variations in weight, height, body type, and movement characteristics. There is also variance in workout types, with similar movements across some types. For example, yoga, circuit training, and pilates may all include similar movements, thereby making it difficult to accurately determine which exercise the user is performing.

### BRIEF SUMMARY

The present disclosure provides for combining signals from multiple devices, including wearable devices, to get a better understanding of what type of workout a user is currently doing, and to detect and log specific details of that workout, such as repetitions in a specific weight lifting or bodyweight exercise. For example, signals may be acquired from cameras and various sensors on different wearable devices. Such sensors may include, for example, inertial measurement units, microphones, etc., and such wearable devices may include, for example, smartwatches, earbuds, smart glasses, etc. The present disclosure further provides for refining activity detection models based on personalized user calibration.

One aspect of the disclosure provides a method for detecting exercise, comprising receiving, by one or more processors, image data from one or more visual input devices, receiving, by the one or more processors, sensor data from one or more sensors of a wearable device, determining, by the one or more processors based on the image data and the sensor data, exercise data including identifying specific poses and movements being performed by a user of the wearable device, identifying exercises being performed based on the determined exercise data, and logging the exercises performed by the user.

According to some examples, the one or more sensors of the wearable device may include a microphone, and the sensor data received by the one or more processors includes audio input from the user. The audio input from the user may include at least one of verbal cues or breathing patterns, and determining the exercises may include determining a count or timing of repetitions based on the verbal cues or breathing patterns.

According to some examples, the one or more sensors of the wearable device include an inertial measurement unit.

The method may include determining a number of repetitions of the identified exercise. Determining the exercise data may include executing a machine learning model. The method may further include requesting, by the one or more processors, user feedback indicating an accuracy of the determined exercise data, receiving, by the one or more processors, the user feedback, and adjusting the machine learning model based on the user feedback. According to some examples, the machine learning model is specific to the user.

Another aspect of the disclosure provides a system for detecting exercise, comprising one or more memories configured to store an exercise detection model and one or more processors in communication with the one or more memories. The one or more processors may be configured to receive image data from one or more visual input devices, receive sensor data from one or more sensors of a wearable device, determine, based on the image data and the sensor data, exercise data including specific poses and movements being performed by a user of the wearable device, identify exercises being performed based on the determined exercise data, and log in the one or more memories the exercises performed by the user.

The one or more sensors may include a microphone, and the sensor data received by the one or more processors comprises audio input from the user. The audio input from the user may include at least one of verbal cues or breathing patterns, and wherein determining the exercises comprises determining a count or timing of repetitions based on the verbal cues or breathing patterns.

The one or more sensors of the wearable device may include an inertial measurement unit.

The one or more processors may be further configured to determine a number of repetitions of the identified exercise. Determining the exercise data may include executing a machine learning model. The one or more processors may be further configured to request user feedback indicating an accuracy of the determined exercise data, receive the user feedback, and adjust the machine learning model based on the user feedback. According to some examples, the machine learning model is specific to the user.

The visual input device may include a home assistant device and the wearable device may include at least one of earbuds or a smartwatch. The one or more processors may reside within at least one of the visual input device or the wearable device. In other examples, at least one of the one or more processors resides within a host device coupled to the visual input device and the wearable device.

Yet another aspect of the disclosure provides a non-transitory computer-readable medium storing instructions executable by one or more processors for performing a method of detecting exercise, comprising receiving image data from one or more visual input devices, receiving sensor data from one or more sensors of a wearable device, determining, based on the image data and the sensor data, exercise data including identifying specific poses and movements being performed by a user of the wearable device, identifying exercises being performed based on the determined exercise data, and logging the exercises performed by the user.

### BRIEF DESCRIPTION OF THE DRAWINGS

FIGS. 1A-C are pictorial diagrams of an example system in use by a user according to aspects of the disclosure.

FIG. 2 is a block diagram of an example system according to aspects of the disclosure.

FIG. 3 is a pictorial diagram of another example system according to aspects of the disclosure.

FIG. 4 is a flow diagram illustrating an example method of detecting a type of exercise being performed by a user according to aspects of the disclosure.

FIG. 5 is a flow diagram illustrating an example method of training a machine learning model to detect exercise types according to aspects of the disclosure.

### DETAILED DESCRIPTION

The present disclosure provides a system and method for accurately detecting exercises performed by a user through a combination of signals from a visual input device and from one or more sensors of a wearable device. For each workout type, an algorithm leverages multimodal inputs for automatic workout detection/identification. Using multiple sources of visual and gestural inputs to detect the same workout results in a higher confidence in the detection. Moreover, it allows for continued detection of the workout, including counting repetitions, even when one or more signals becomes unavailable, such as if the user moves out of a field of view of the visual input device.

The visual input device may be, for example, a camera or other visual detection tool. The device may be included in any of a number of devices, such as a home assistant device, laptop, tablet, etc. According to some examples, visual input may be received from multiple different devices having different positions with respect to the user, and therefore providing different angles of image capture of the user's positions and movements.

The wearable device may be one or more of a smartwatch, earbuds, fitness tracking band, smartglasses, or any other wearable device having one or more sensors. The sensors may include, for example, inertial measurement units (IMUs) including devices such as accelerometers, gryoscopes, etc., temperature sensors, strain gauges, heart rate sensors, or any other types of sensors in wearable devices.

According to some examples, one or more of the signals used by the one or more processors to detect exercise may be an audio signal. For example, a microphone on the one or more wearable devices or a surrounding device, such as a home assistant device, tablet, phone, home monitoring system, etc., may capture audio input from the user. Such audio input may include, for example, counting repetitions or exercises, breathing patterns, grunts, voice commands, or any other audio input. The audio signals may be combined with other signals from the wearable device and/or visual input device to more accurately detect specific movements and types of exercise.

In some examples, the system may also receive manual input from the user. For example, such input may be used to more accurately detect workout type, count repetitions, or otherwise calibrate the system. According to one example, the system may include a calibration mode in which users are asked to perform specific workout actions to calibrate specific activities and/or repetitions. For example, the user could be instructed to perform repetition-specific weightlifting exercises while wearing the one or more wearable devices. User feedback may additionally or alternatively be received during subsequent workouts to improve detection. For example, the user may modify a workout log to record a different exercise or number of repetitions than detected by the model, and such corrections may be used to update the exercise detection model. Opportunities for additional calibration may be automatically identified, for example, when the user connects a new type of device or when the system repeatedly misidentifies a type of workout.

According to some examples, a user's preferred workouts may be automatically prioritized.

This multimodal system compensates for many of the limitations of single-device systems. The accuracy of camera-based systems is highly dependent on the user's body position and angle with respect to the camera, as well as on the speed of the movement, as a quick movement may be too blurred or use too few frames for the camera to catch the necessary poses. For example, if the user is doing jumping jacks and moves partially out of the camera frame, the system will have a harder time correctly detecting each repetition. However, if that user is also wearing a watch or headphones with movement sensors, the combination of the visual signal from the camera and the IMU signal on the wearable can be used to detect the initial exercise type, and the IMU signal can be used to keep accurate counting if the camera signal becomes less accurate.

### Example Systems

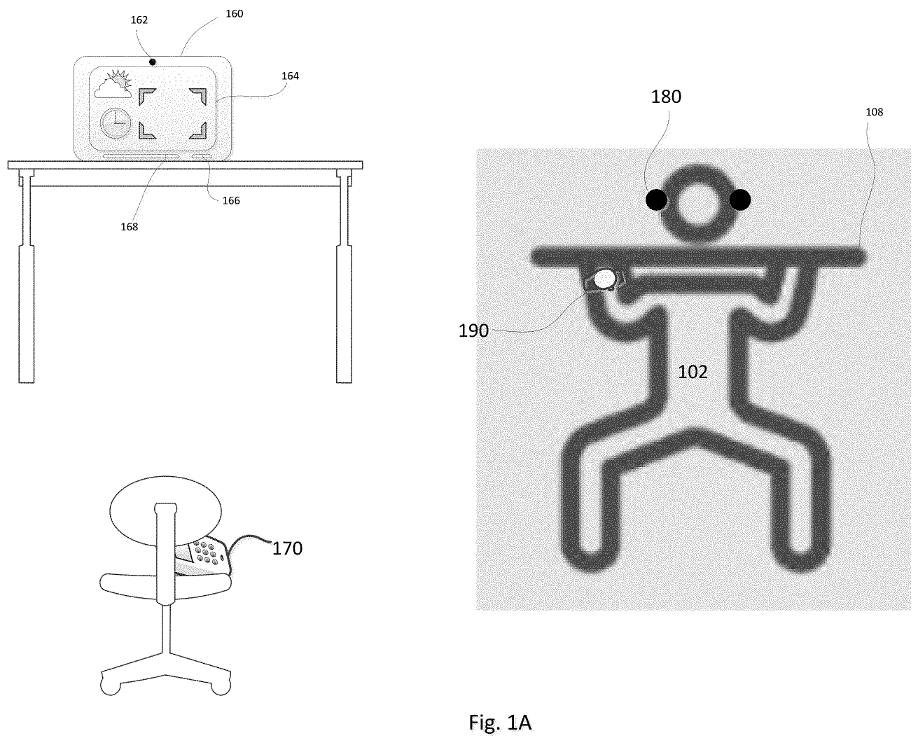

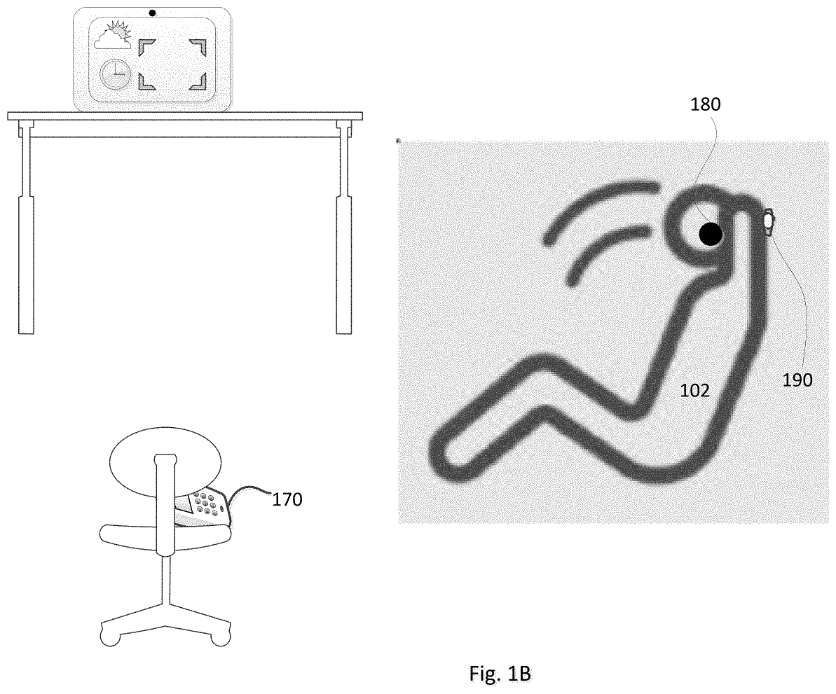

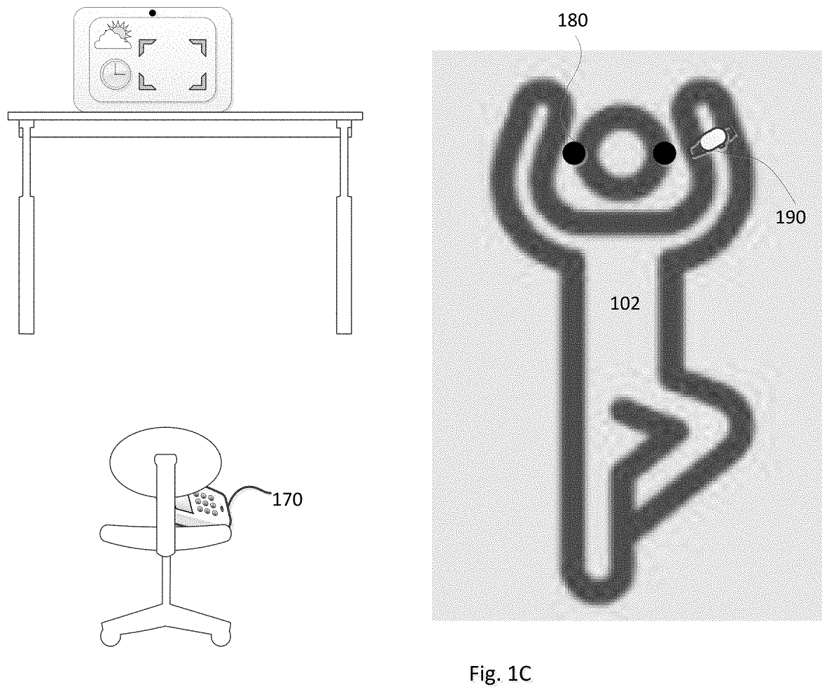

FIGS. 1A-C are pictorial diagrams of an example system in use as a user 102 performs different types of exercises including different poses, movements, and equipment. The system includes one or more wearable devices 180, 190 worn by a user and one or more surrounding devices, such a visual input device 160 and phone 170. The exercises may be detected by any combination or one or more wearable devices and one or more surrounding devices. Moreover, the detection may be performed by a processing unit in either of the wearable devices or the surrounding devices.

In each of FIGS. 1A-C, user 102 is wearing wireless computing devices 180, 190. In these examples, the wireless computing devices include earbuds 180 worn on the user's head and a smartwatch 190 worn on the user's wrist. It should be understood that while the user 102 is wearing two different types of wearable devices in these examples, additional or fewer devices may be worn. Moreover, the type of wearable device may be varied. For example, in addition or alternative to the smartwatch and earbuds, the wearable device may include smart glasses, a fitness tracking band, an augmented reality or virtual reality headset, or any other wearable electronic device that includes one or more sensors and is capable of electronic communication with nearby devices.

The system of FIGS. 1A-C also includes a visual input device 160 that includes an image capture device, such as camera 162. In the examples shown the visual input device 160 is a home assistant hub that also includes a display 164, microphone 166, and speaker 168. However, it should be understood that any of a variety of types of visual input devices may be used that may or may not have displays, speakers, or other features. Examples of other types of visual input devices include, without limitation, mobile phones, tablets, laptops, smart TVs, home monitoring systems, etc.

The examples of FIGS. 1A-C further includes mobile phone 170. The mobile phone 170 may also include an image capture device and may therefore function as a visual input device, such as a second visual input device when the device 160 is also in use. For example, the phone 170 and visual input device 160 may be placed at different angles with respect to the user and thereby capture the user's poses and movements from a different angle. In the example shown, the visual input device 160 is on a table at a first position relative to the user 102 while the phone 170 in on a chair at a second position relative to the user 102.

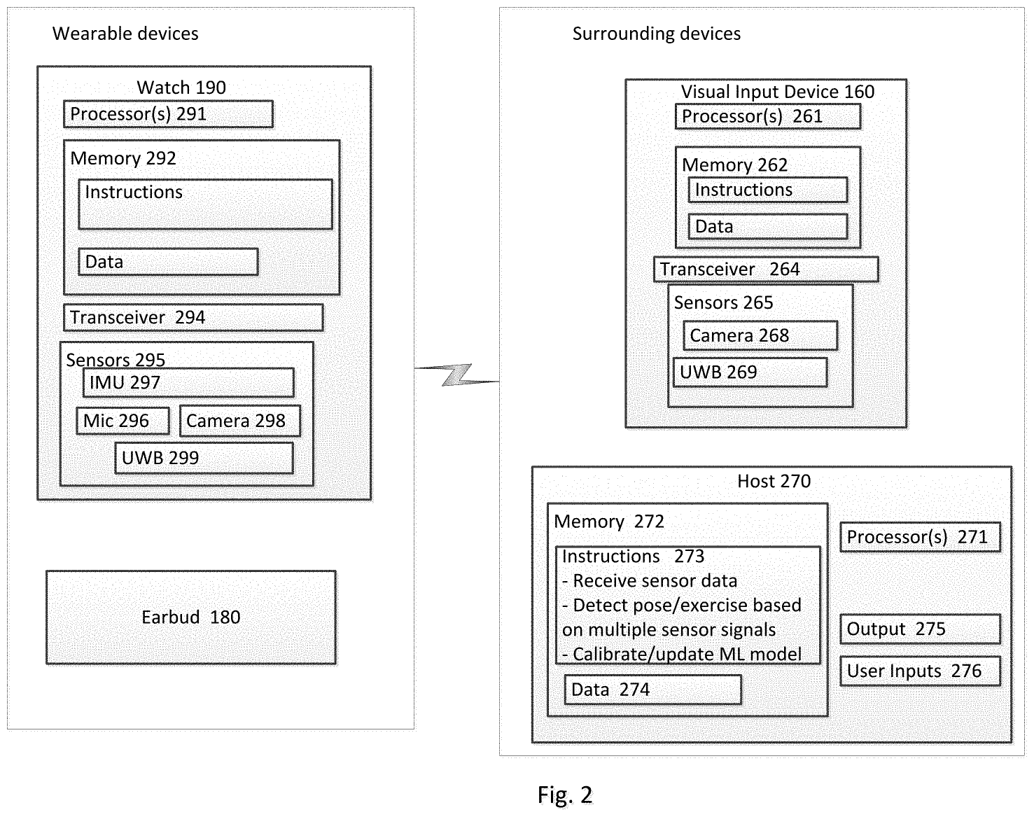

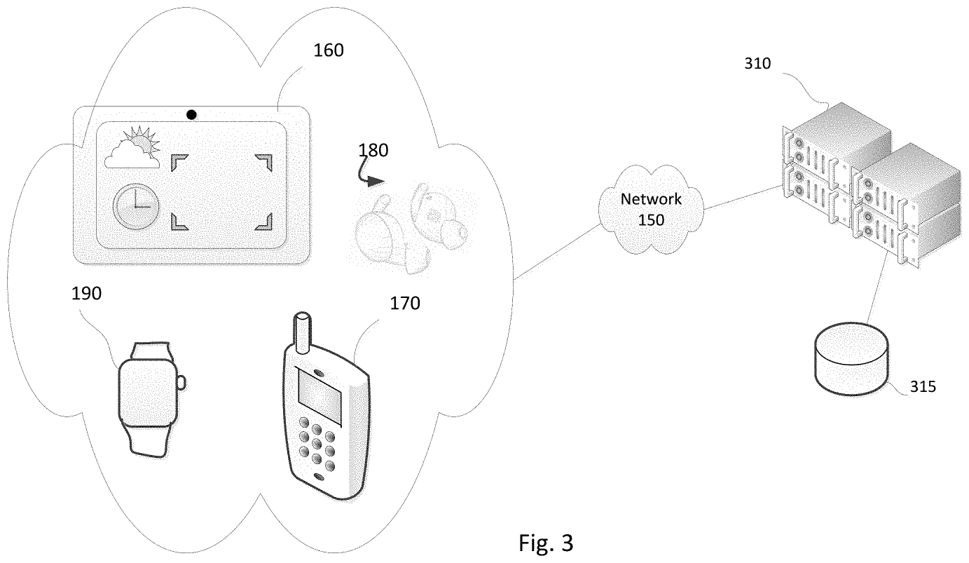

Each of the one or more wearable devices 180, 190 and one or more surrounding devices, including visual input device 160 and phone 170 in this example, may be in wireless communication with one another, as explained in further detail in connection with FIGS. 2-3. Moreover, any of the wearable devices 180, 190 or surrounding devices 160, 170 may be capable of receiving sensor signals from other devices and processing such signal to determine the type of exercise performed by the user, including specific movements, poses, etc.

The wireless computing devices 180, 190 worn by the user may detect particular types of exercises and repetitions of such exercises performed by the user 102. As shown in FIG. 1A, the user 102 is holding a barbell 108 at shoulder height and performing weighted sumo squats. The smartwatch 190 may detect that the user's arm are pointed upright, for example based on a gyroscope in the watch, and that the user's hands are at shoulder height based on a relative proximity to the earbuds 180. Moreover, the smartwatch may detect a strain in the user's wrist as the user 102 holds the barbell 108. The smartwatch 190 and/or earbuds 180 may detect an up/down movement as the user 102 performs each squat. The visual input device 160 may detect the positioning of the user and the presence and position of the barbell 108. For example, images captured of the user 102 may be processed using image recognition techniques. According to some examples, the images may be segmented to detect the user and any equipment used by the user, and compared to a catalogue of various exercise poses stored in memory. Based on the received visual input, it may be determined that the user is performing weighted sumo squats, as opposed to narrow-stance squats, lunges, or other types of exercises that may have similar movements.

In addition to detecting the type of exercise, the system may detect a number of repetitions performed. For example, the repetitions may be detected based on signals from IMUs in the wearable devices 180, 190 based on the number of detected up/down movements, signals from the visual input device 160 based on detected poses, and/or signals from an audio input device in any of the wearable or surrounding devices based on changes in breath, verbal cues such as counting, etc. The signals from multiple devices of different types may be correlated to provide a higher confidence for the detected type of exercise and number of repetitions. For example, as a number of different devices providing input signals increases, an accuracy in detection of exercise type and number of repetitions may also increase.

FIG. 1B illustrates the user 102 performing a different type of exercise, specifically sit-ups. In this example, the earbuds 180 and/or smartwatch 190 may detect the up/down movements using, for example, IMUs. Moreover, the wearable devices 180, 190 may determine that the user's hands are behind the user's head based on a proximity of the smartwatch 190 to the earbuds 190. Signals from the visual input device 160 may be used to confirm that the user 102 is doing sit-ups, as opposed to squats or any other type of exercise including up/down movements.

FIG. 1C illustrates the user 102 doing yoga. As yoga typically includes movements that are somewhat slower and less repetitious than other exercise types, it may be difficult to detect the user's movement and pose based on the signals from the wearable devices. However, signals from the visual input device 160 may be used to determine the specific poses.

While the examples of FIGS. 1A-C illustrate a few examples of different types of exercises, it should be understood that such examples are not limiting and that any of a number of different types of exercises may be detected. For example and without limitation, the types of exercises may include various types of weightlifting exercises, calisthenics, yoga exercise, pilates exercises, barre, step, aerobics, martial arts, dance, etc.

While in the example shown the wearable devices 180, 190 include earbuds and a smartwatch, it should be understood that in other examples any of a number of different types of wireless devices may be used. For example, the wireless devices may include a headset, a head-mounted display, smart glasses, a pendant, an ankle-strapped device, a waist belt, etc. Moreover, while two wearable devices are shown as being used to detect the exercises in FIGS. 1A-C, additional or fewer wearable devices may be used. Further, while two earbuds 180 are shown, detection of the user's movements may be performed using only one or both earbuds.

FIG. 2 further illustrates example computing devices in the system, and features and components thereof. While two example wearable devices are shown in communication with two example surrounding devices, additional or fewer wearable or surrounding devices may be included. The wearable devices may be communicatively coupled to each other, to all surrounding devices, or only to selected surrounding devices. According to some examples, processing of signals and determination of exercises may be performed at a single device, such as the phone 170 or visual input device 160. According to other examples, processing may be performed by different processors in the different devices in parallel, and combined at one or more devices.

Each of the wearable wireless devices 180, 190 includes various components, though such components are only illustrated with respect to the smartwatch 190 for simplicity. Such components may include a processor 291, memory 292 including data and instructions, transceiver 294, sensors 295, and other components typically present in wearable wireless computing devices. The wearable devices 180, 190 may have all of the components normally used in connection with a wearable computing device such as a processor, memory (e.g., RAM and internal hard drives) storing data and instructions, user input, and output.

Each of the wireless devices 180, 190 may also be equipped with short range wireless pairing technology, such as a Bluetooth transceiver, allowing for wireless coupling with each other and other devices. For example, transceiver 294 may include an antenna, transmitter, and receiver that allows for wireless coupling with another device. The wireless coupling may be established using any of a variety of techniques, such as Bluetooth, Bluetooth low energy (BLE), ultra wide band (UWB), etc.

The sensors 295 may be capable of detecting the user's movements, in addition to detecting other parameters such as relative proximity to one another, biometric information such as heartrate and oxygen levels, etc. The sensors may include, for example, IMU sensors 297, such as an accelerometer, gyroscope, etc. For example, the gyroscopes may detect inertial positions of the wearable devices 180, 190, while the accelerometers detect linear movements of the wearable devices 180, 190. Such sensors may detect direction, speed, and/or other parameters of the movements. The sensors may additionally or alternatively include any other type of sensors capable of detecting changes in received data, where such changes may be correlated with user movements. For example, the sensors may include a barometer, motion sensor, temperature sensor, a magnetometer, a pedometer, a global positioning system (GPS), proximity sensor, strain gauge, camera 298, microphone 296, UWB sensor 299, etc. The one or more sensors of each device may operate independently or in concert.

The proximity sensor or UWB sensor may be used to determine a relative position, such as angle and/or distance, between two or more devices. Such information may be used to detect a relative position of devices, and therefore detect a relative position of the user's body parts on which the wearable devices are worn.

The strain gauge may be positioned, for example, in the smartwatch such as in a main housing and/or in a band of the smartwatch. Thus, for example, as a user's arm tenses, such as when the user lifts a weight, the strain gauge may measure an amount of tension. According to some examples, measurements of the strain gauge may be used to measure how much weight is being lifted.

The surrounding devices may include components similar to those described above with respect to the wearable devices. For example, the visual input device 160 may include a processor 161, memory 262, transceiver 264, and sensor 265. Such sensors may include, without limitation, one or more cameras 268 or other image capture devices, such as thermal recognition, etc., UWB sensor 269, and any of a variety of other types of sensors.

The camera 268 or other image capture device of the visual input device 160 may capture images of the user, provided that the user has configured the visual input device 160 to enable the camera and allow the camera to receive input for use in association with other devices in detecting exercises. The captured images may include one or more image frames, video stream, or any other type of image. Image recognition technique may be used to identify a shape or outline of the user and the user's poses and/or movements. Such image recognition techniques may include image segmentation, comparison to a library of stored images associated with information identifying particular poses or movements, etc.

In addition to detecting pose, the camera 268 may capture additional information, such as equipment being used. Examples of such equipment may include weights, jump ropes, resistance bands, step platforms, etc. According to some examples, the camera 268 may be used to detect a type and/or an amount of weight being lifted. For example, the camera 268 may capture a size and shape of a weight being lifted, which may be used to determine a type of weight, such as dumbbell, barbell, kettlebell, etc. The size and shape may also be used to estimate the amount of weight. According to some examples, image recognition and/or optical character recognition techniques may be used to read numbers on the weight, the numbers indicating an amount of weight being lifted.

According to some examples, equipment may be integrated with the system as a satellite device. For example, the exercise equipment may include UWB connectivity for precise movement detection and device identification.

The host device 270 may include similar components as those described above with respect to the visual input device 160. The host device 270 may be the phone 170 of FIGS. 1A-C, or any of the wearable or surrounding devices. In that regard, the host device 270 may receive signals, either directly or indirectly through one or more other devices, from both the wearable devices 180, 190 and the visual input device 160. However, as mentioned above, each device may perform its own processing independently or in a distributed manner, as opposed to designating any particular device as the host.

The host device 270 may also include one or more processors 271 in communication with memory 272 including instructions 273 and data 274. The host device 270 may further include elements typically found in computing devices, such as output 275, input 276, communication interfaces, etc.

The input 276 and output 275 may be used to receive information from a user and provide information to the user. The input may include, for example, one or more touch sensitive inputs, a microphone, a camera, sensors, etc. Moreover, the input 276 may include an interface for receiving data from the wearable wireless devices 180, 190 and the other surrounding devices. The output 275 may include, for example, a speaker, display, haptic feedback, etc.

The one or more processor 271 may be any conventional processors, such as commercially available microprocessors. Alternatively, the one or more processors may be a dedicated device such as an application specific integrated circuit (ASIC) or other hardware-based processor. Although FIG. 2 functionally illustrates the processor, memory, and other elements of host device 270 as being within the same block, it will be understood by those of ordinary skill in the art that the processor, computing device, or memory may actually include multiple processors, computing devices, or memories that may or may not be stored within the same physical housing. Similarly, the memory may be a hard drive or other storage media located in a housing different from that of host device 270. Accordingly, references to a processor or computing device will be understood to include references to a collection of processors or computing devices or memories that may or may not operate in parallel.

Memory 272 may store information that is accessible by the processors 271, including instructions 273 that may be executed by the processors 271, and data 274. The memory 272 may be of a type of memory operative to store information accessible by the processors 271, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. The subject matter disclosed herein may include different combinations of the foregoing, whereby different portions of the instructions 273 and data 274 are stored on different types of media.

Data 274 may be retrieved, stored or modified by processors 271 in accordance with the instructions 273. For instance, although the present disclosure is not limited by a particular data structure, the data 274 may be stored in computer registers, in a relational database as a table having a plurality of different fields and records, XML documents, or flat files. The data 274 may also be formatted in a computer-readable format such as, but not limited to, binary values, ASCII or Unicode. By further way of example only, the data 274 may be stored as bitmaps comprised of pixels that are stored in compressed or uncompressed, or various image formats (e.g., JPEG), vector-based formats (e.g., SVG) or computer instructions for drawing graphics. Moreover, the data 274 may comprise information sufficient to identify the relevant information, such as numbers, descriptive text, proprietary codes, pointers, references to data stored in other memories (including other network locations) or information that is used by a function to calculate the relevant data.

The instructions 273 may be executed to detect a type of exercise, including specific poses and movements, performed by the user based on raw data received from the sensors 295 of the wireless wearable devices 180, 190 and the sensors 265 of the surrounding devices. For example, the processor 271 may execute a machine learning algorithm whereby it compares images of the received raw data with stored image corresponding to particular exercises, and detects the exercise performed based on the comparison. Moreover, the instructions 273 may be executed to detect a number of repetitions of the exercise, such as by counting movements based on IMU signals, breaths, verbal cues, visual cues, or any combination of these or other types of signals.

The host device 270 may further be configured to calibrate the machine learning model to improve the accuracy of detection of subsequent exercises. For example, the host device 270 may request user feedback, either through its own input/output 275/276 or by issuing a command to any of the wearable or surrounding devices. Once received, the user feedback may be used to correct the detected exercises. For example, the user feedback may be compared to the determinations made by the one or more processors 271 in executing the machine learning model to detect exercise. If the user feedback indicates a different exercise than was detected, or otherwise indicates that the determination by the processors 271 was wrong, the processors may store updated information associating the combination of received signals with the exercise input by the user.

FIG. 3 illustrates the wireless wearable devices 180, 190 in communication with each other, the visual input device 160, and the host device 170. While in some examples every device may be coupled to every other device, in some examples one or more devices may only be coupled to selected other devices. The wireless connections among the devices may be, for example, short range pairing connections, such as Bluetooth. Other types of wireless connections are also possible. In this example, the devices 160-190 are further in communication with server 310 and database 315 through network 150. For example, the wireless wearable devices 180, 190 may be indirectly connected to the network 150 through the phone 170. In other examples, one or both of the wireless wearable devices 180, 190 may be directly connected to the network 150, regardless of a presence of the phone 170.

The network 150 may be, for example, a LAN, WAN, the Internet, etc. The connections between devices and the network may be wired or wireless.

The server computing device 310 may actually include a plurality of processing devices in communication with one another. According to some examples, the server 310 may execute the machine learning model for determining a particular type of exercise being performed based on input from the wearable devices and surrounding devices. For example, the wearable devices 180, 190 may transmit raw data detected from their IMUs or other sensors to the server 310, and the surrounding devices may similarly transmit raw audio or visual data if authorized by the user. The server 310 may perform computations using the received raw data as input, determine the type of exercise performed, and send the result back to one or more of the devices 160-190. According to other examples, one or more of the devices 160-190 may access data, such as a library of image or other data correlated with particular exercises, and use such data in detecting the particular exercise, movements, pose, etc.

Databases 315 may be accessible by the server 310 and computing devices 160-190. The databases 315 may include, for example, a collection of data from various sources corresponding to particular types of exercises. For example, the data may include images of raw data streams from IMUs or other sensors in wearable devices, the raw data streams corresponding to particular types of exercise. Such data may be used in the machine learning model executed by the server 310 or by any of the devices 160-190.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

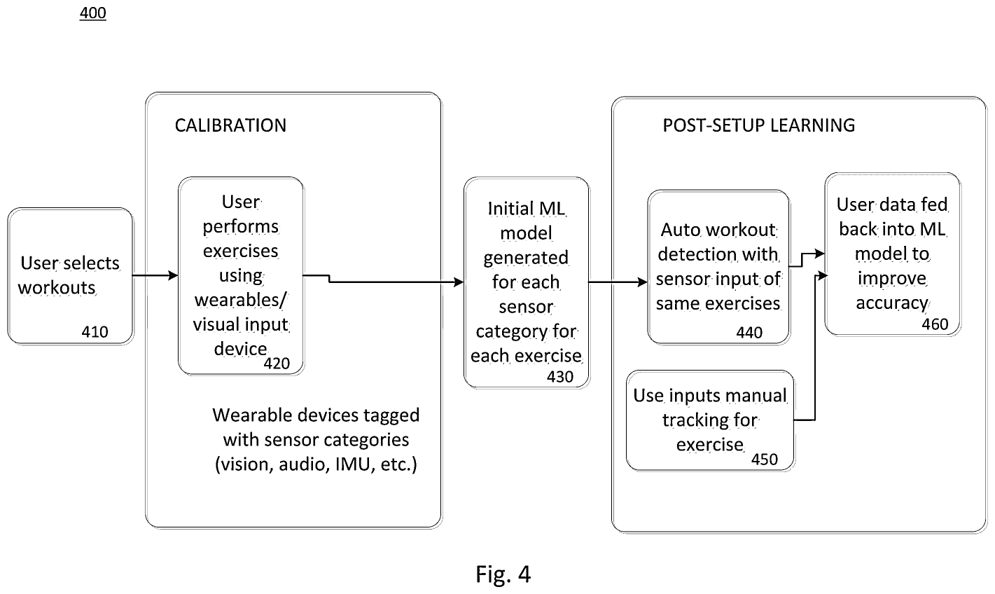

FIG. 4 illustrates an example method 400 of calibrating a system for detecting exercises of a user. The method 400 may be performed by any wearable or surrounding device adapted to detect exercises performed by the user as described herein.

In block 410, the user selects a workout. For example, the user may enter input specifying a particular type of exercise that the user intends to perform. Such workouts/exercise may include stretching, aerobics, weight training, yoga, pilates, martial arts, kickboxing, dancing, or any of numerous other possible types of exercise.

In block 420, the user performs the exercises in the workout while wearing the one or more wearable devices and using the visual input device and/or other surrounding devices. The wearable device may be tagged with information identifying the types of sensors that are receiving information related to the workout. For example, the sensors may include vision sensors, audio sensors, IMUs, temperature sensors, heart rate sensors, etc.

In block 430, an initial machine learning model is generated for each sensor category for each exercise. For example, if the workout is yoga, an initial machine learning model may be generated for each exercise or pose (e.g., sun salutation, high plank, warrior pose, etc.) for each sensor. Accordingly, for each IMU a plurality of machine learning models may be generated, with a model for each exercise. For each vision sensor a plurality of machine learning models may be generated, with a model for each exercise, etc. According to some examples, the initial machine learning models may be generated using federated learning. In block 440, the machine learning models are used to automatically detect subsequent workouts using sensor input from the wearable and surrounding devices. In block 450, manual input may be received from the user. Such manual input may be used to correct the automatically detected workout information (block 660). For example, the initial machine learning model may be updated using the manual user input, thereby improving the accuracy of the machine learning model.

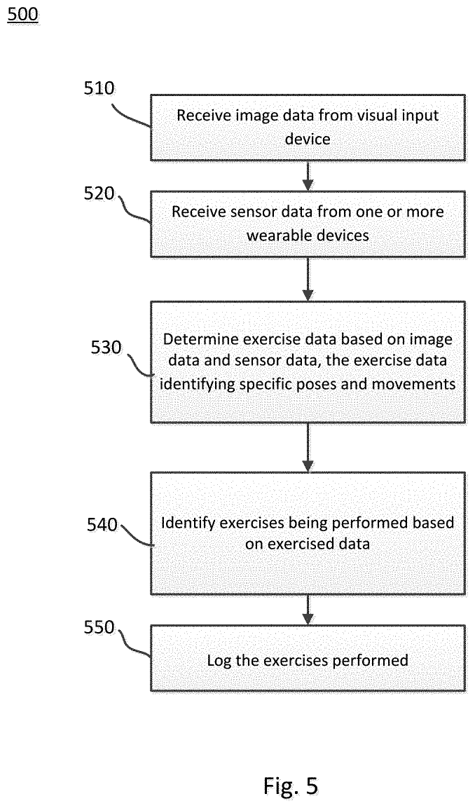

FIG. 5 illustrates an example method 500 of detecting a type of exercise being performed by a user. The method may be performed by one or more processors in a wearable device, a surrounding device, or a separate host device in communication with the wearable and surrounding devices.

In block 510, image data is received from a visual input device. By way of example only, such visual input device may be a camera within a home assistant hub device.

In block 520, sensor data is received from the one or more wearable devices. Such wearable devices may include earbuds, smartwatch, headset, smartglasses, fitness band, etc. The sensor data may be data from one or more sensors, such as IMUs, UWB sensors, microphones, temperature sensors, strain gauges, or any other type of sensor that may be included in a wearable device.

In block 530, exercise data is determined based on the image data and the sensor data. The exercise data may identify specific poses and movements. For example, the poses may include any positioning of the user's body parts. The movements may include types of motion, such as arms waving, head raising and lowering, etc. The exercise data may also include an amount of weight being used, other types of equipment used, or any of a variety of other information.

In block 540, the exercises being performed may be identified based on the exercise data. For example, the exercises may include specific exercises, such as jumping jacks, weighted sumo squats, sit-ups, etc. Identifying the exercise may also include a identifying a count of a number of repetitions performed.

In block 550, the identified exercises are logged. For example, a number or duration of each particular identified exercise may be saved in memory. Such information may be used by the user to keep track of fitness goals and progress towards such goals, etc.

The multimodal system described herein compensates for many of the limitations of single-device systems. The accuracy of camera-based systems is highly dependent on the user's body position and angle with respect to the camera, as well as on the speed of the movement, as a quick movement may be too blurred or use too few frames for the camera to catch the necessary poses. For example, if the user is doing jumping jacks and moves partially out of the camera frame, the system will have a harder time correctly detecting each repetition. However, if that user is also wearing a watch or headphones with movement sensors, the combination of the visual signal from the camera and the IMU signal on the wearable can be used to detect the initial exercise type, and the IMU signal can be used to keep accurate counting if the camera signal becomes less accurate.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for detecting exercise, comprising:
receiving, by one or more processors, image data from one or more visual input devices;
receiving, by the one or more processors, sensor data from one or more sensors of a wearable device;
determining, by the one or more processors based on the image data and the sensor data, exercise data including identifying specific poses and movements being performed by a user of the wearable device;
identifying exercises being performed based on the determined exercise data; and
logging the exercises performed by the user.

2. The method of claim 1, wherein the one or more sensors of the wearable device comprise a microphone, and the sensor data received by the one or more processors comprises audio input from the user.

3. The method of claim 2, wherein the audio input from the user comprises at least one of verbal cues or breathing patterns, and wherein determining the exercises comprises determining a count or timing of repetitions based on the verbal cues or breathing patterns.

4. The method of claim 1, wherein the one or more sensors of the wearable device comprise an inertial measurement unit.

5. The method of claim 1, further comprising determining a number of repetitions of the identified exercise.

6. The method of claim 1, wherein determining the exercise data comprises executing a machine learning model.

7. The method of claim 6, further comprising:
requesting, by the one or more processors, user feedback indicating an accuracy of the determined exercise data;
receiving, by the one or more processors, the user feedback; and
adjusting the machine learning model based on the user feedback.

8. The method of claim 7, wherein the machine learning model is specific to the user.

9. A system for detecting exercise, comprising:
one or more memories configured to store an exercise detection model;
one or more processors in communication with the one or more memories, the one or more processors configured to:
receive image data from one or more visual input devices;
receive sensor data from one or more sensors of a wearable device;
determine, based on the image data and the sensor data, exercise data including specific poses and movements being performed by a user of the wearable device;
identify exercises being performed based on the determined exercise data; and
log in the one or more memories the exercises performed by the user.

10. The system of claim 9, wherein the one or more sensors of the wearable device comprise a microphone, and the sensor data received by the one or more processors comprises audio input from the user.

11. The system of claim 10, wherein the audio input from the user comprises at least one of verbal cues or breathing patterns, and wherein determining the exercises comprises determining a count or timing of repetitions based on the verbal cues or breathing patterns.

12. The system of claim 9, wherein the one or more sensors of the wearable device comprise an inertial measurement unit.

13. The system of claim 9, wherein the one or more processors are further configured to determine a number of repetitions of the identified exercise.

14. The system of claim 9, wherein determining the exercise data comprises executing a machine learning model.

15. The system of claim 14, wherein the one or more processors are further configured to:
request user feedback indicating an accuracy of the determined exercise data;
receive the user feedback; and
adjust the machine learning model based on the user feedback.

16. The system of claim 15, wherein the machine learning model is specific to the user.

17. The system of claim 9, wherein the visual input device comprises a home assistant device and the wearable device comprises at least one of earbuds or a smartwatch.

18. The system of claim 9, wherein the one or more processors reside within at least one of the visual input device and or wearable device.

19. The system of claim 9, wherein at least one of the one or more processors resides within a host device coupled to the visual input device and the wearable device.

20. A non-transitory computer-readable medium storing instructions executable by one or more processors for performing a method of detecting exercise, comprising:
receiving image data from one or more visual input devices;
receiving sensor data from one or more sensors of a wearable device;
determining, based on the image data and the sensor data, exercise data including identifying specific poses and movements being performed by a user of the wearable device;
identifying exercises being performed based on the determined exercise data; and
logging the exercises performed by the user.
